(19) United States
(12) Patent Application Publication
(10) Pub. No.: US 2012/0117326 A1
(43) Pub. Date: May 10, 2012

(54) APPARATUS AND METHOD FOR ACCESSING CACHE MEMORY

(75) Inventors: YEN-JU LU, HSINCHU CITY (TW); JUI-YUAN LIN, CHIAYI COUNTY (TW)

(73) Assignee: REALTEK SEMICONDUCTOR CORP., HSINCHU (TW)

(21) Appl. No.: 13/288,079

(22) Filed: Nov. 3, 2011

(30) Foreign Application Priority Data
Nov. 5, 2010 (TW) 099138050

(51) Int. Cl. G06F 12/08

(52) U.S. Cl. 711/122; 711/E12.024

(57) ABSTRACT

The present invention relates to an apparatus and a method for accessing a cache memory. The cache memory comprises a level-one memory and a level-two memory. The apparatus for accessing the cache memory according to the present invention comprises a register unit and a control unit. The control unit receives a first read command and a reject datum of the level-one memory and stores the reject datum of the level-one memory to the register unit. Then the control unit reads and stores a stored datum of the level-two memory to the level-one memory according to the first read command.

### FIELD OF THE INVENTION

The present invention relates generally to an apparatus and a method for accessing a memory, and particularly to an apparatus and a method for accessing a cache memory in a microprocessor.

### BACKGROUND OF THE INVENTION

For computer systems, the demands in processing speed as well as storing and reading considerable quantities of data and/or instructions are increasing continuously. One of the methods for accelerating processors to access stored data is to store a copy of the data recently read by the processors to a cache memory. When the requested data by the processors are located in the cache memory, it will be much faster to read from the cache memory than from other memories.

The execution efficiency of a general processor, in particular an embedded processor mostly used in system chips, is usually limited by the waiting time for accessing an external memory. In other words, when a processor accesses an external memory, the operational function of the processor will in the idle status. As shown in FIG. 1, in order to improve the execution efficiency of a processor 8′, the processor 8′ can have a built-in cache memory 10′ for accelerating data access. According to FIG. 1, it is known that the processor 8′ comprises a processing unit 40′, which store a copy of the data frequently accessed to the cache memory 10′. Thereby, if the processing unit 40′ needs to use those frequently-accessed data, they can be accessed in the cache memory 10′. Because it is not necessary for the processing unit 40′ to access those frequently-accessed data in an external memory 20′ via an external bus 34′, time for data access can be saved, and hence accelerating much overall processing speed of the processor 8′. Nonetheless, when a cache miss happens, the processing unit 40′ still needs to access the external memory 20′ through the external bus 34′, in which the coordination of the internal bus 32′ and the external bus 34′ is achieved by a bus controller 30′.

FIG. 2 shows a system architecture of data access in a cache memory according to the prior art. As shown in the figure, the cache memory according to the prior art comprises a level-one memory 50′ and a level-two memory 60′. The level-one memory 50′ includes a first memory unit 52′ (instruction cache) and a second memory unit 54′ (data cache). When the processing unit cannot find the desired data in the first memory unit 52′, it will search the level-two memory 60′. That is to say, the first memory unit 52′ transmits a read command to the level-two memory 60′, and rejects a reject datum to the level-two memory 60′, which receives the read command and search the data inside the level-two memory 60′ according to the read command. If the stored datum desired by the processing unit 40′ is found, the level-two memory 60′ transmits the stored datum back to the first memory unit 52′, and stores the reject datum rejected by the first memory unit 52′ to the level-two memory 60′. However, when both of the first and second memory units 52′, 54′ need the level-two memory 60′ to search the stored data, the second memory unit 54′ cannot interchange data with the level-two memory 60′ until the data interchange between the first memory unit 52′ and the level-two memory 60′ is completed. Thereby, the access time of the cache memory is increased while the access efficiency thereof is decreased.

### SUMMARY

An objective of the present invention is to provide an apparatus and a method for accessing a cache memory for enhancing the access efficiency of the cache memory, and hence solving the problem in the prior art.

The cache memory comprises a level-one memory and a level-two memory. The apparatus for accessing the cache memory according to the present invention comprises a register unit and a control unit. The method for accessing a cache memory according to the present invention comprises steps of the control unit receiving a first read command and a reject datum of the level-one memory, and the control unit storing the reject datum of the level-one memory to the register unit and reading and storing a stored datum of the level-two memory to the level-one memory according to the first read command.

### BRIEF DESCRIPTION OF THE DRAWINGS

FIG. 1 shows a system architecture of data access via a cache memory according to the prior art;

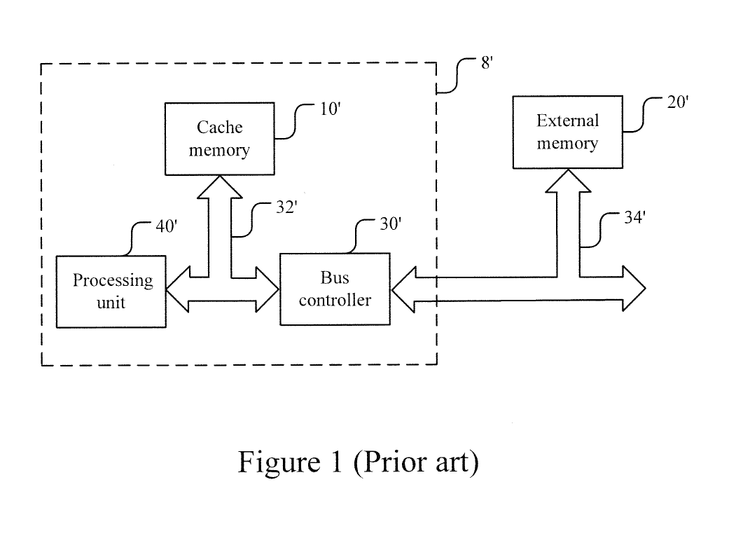

FIG. 2 shows a system architecture of data access in a cache memory according to the prior art;

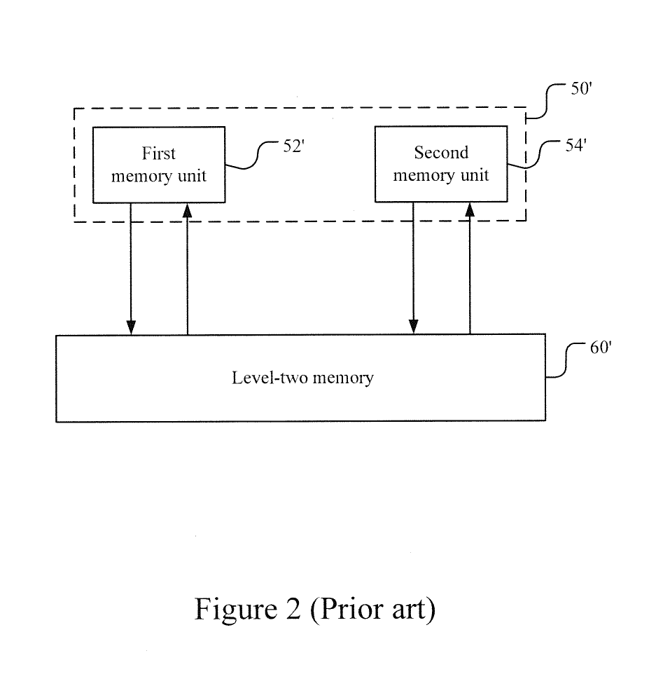

FIG. 3 shows a block diagram according to a preferred embodiment of the present invention;

FIG. 4 shows a schematic diagram of data access according to the preferred embodiment of FIG. 3;

FIG. 5 shows a schematic diagram of data access according to another preferred embodiment of the present invention; and

FIG. 6 shows a schematic diagram of data access according to the preferred embodiment of FIG. 5.

### DETAILED DESCRIPTION

In order to make the structure and characteristics as well as the effectiveness of the present invention to be further understood and recognized, the detailed description of the present invention is provided as follows along with embodiments and accompanying figures.

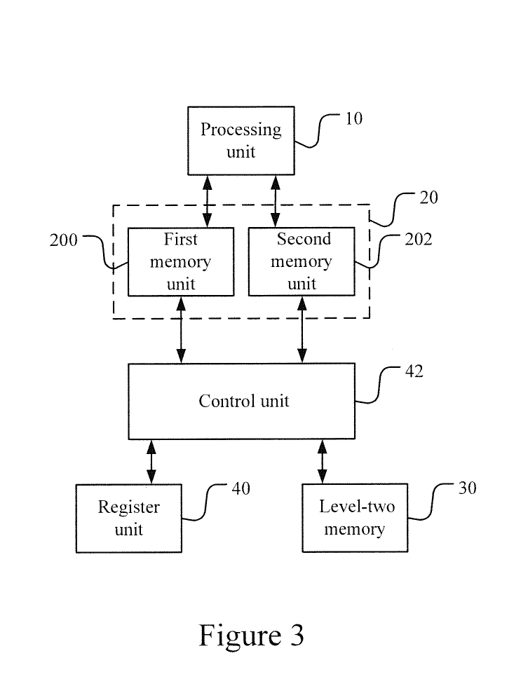

FIG. 3 shows a block diagram according to a preferred embodiment of the present invention. As shown in the figure, the cache memory according to the present invention is coupled to a processing unit 10, which comprises a level-one memory 20 and a level-two memory 30. The apparatus for accessing a cache memory according to the present invention comprises a register unit 40 and a control unit 42. The register unit is used for storing a reject datum rejected by the level-one memory 20. The control unit 42 is used for receiving a first read command and the reject datum of the level-one memory 20, storing the reject datum of the level-one memory 20 to the register unit, and reading and storing a stored datum of the level-two memory 30 to the level-one memory 20 according to the first read command. When the level-one memory 20 has no extra storage space, and the control unit 42 receives the first read command and will read the stored data in the level-two memory 30, the level-one memory 20 rejects one of the plurality of stored data stored therein as the reject datum and stores the reject datum to the register unit 40. And the control unit 42 can store the stored datum of the level-two memory 30 to the corresponding address of the reject datum in the level-one memory 20. The level-one memory 20 can further include a plurality of flags corresponding to said plurality of reject data, respectively. The level-two memory 30 can further include a plurality of flags corresponding to the plurality of stored data, respectively. Thereby, the control unit 42 can access the plurality of reject data and the plurality of stored data by means of the plurality of flags.

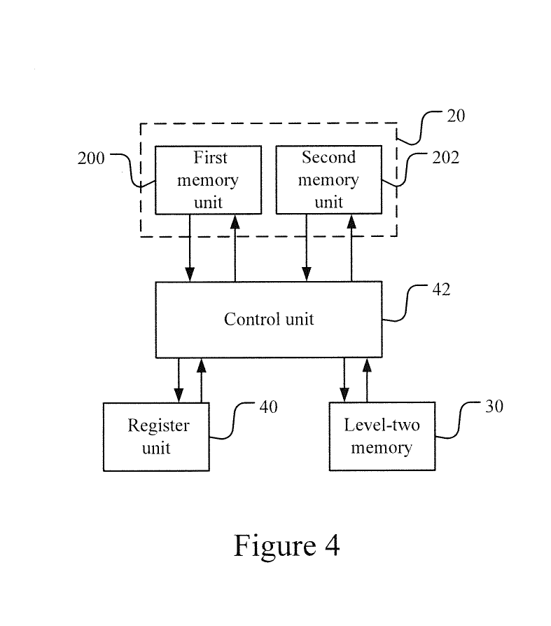

FIG. 4 shows a schematic diagram of data access according to the preferred embodiment of FIG. 3. As shown in the figure, the level-one memory 20 according to the present invention includes a first memory unit 200 and a second memory unit 202. According to the present embodiment, the first memory unit 200 can correspond to the instruction cache (I-Cache) to be used by the processing unit 10 for transmitting instructions; the second memory unit 202 can correspond to the data cache (D-Cache) for providing data to the processing unit 10 for operations.

When both of the first and second memory units 200, 202 need to read data from the level-two memory 30, the first memory unit 200 produces a first read command and transmits the first read command to the control unit 42. At this moment, if the storage space of the first memory unit 200 is full, the first memory unit 200 will reject a reject datum to the control unit 42 and spare a storage space for storing the returned datum from the level-two memory 30.

Next, the control unit 42 will stores the received reject datum in the register unit 40 and checks if a first datum specified by the first read command is stored in the level-two memory 30. At this time, the second memory 202 can also transmit a second read command to the control unit 42. The actions described above can be performed simultaneously, and hence enhancing the access efficiency of the cache memory according to the present invention. The above-mentioned term “performed simultaneously” means that the times for performing two actions are partially or totally overlapped.

Then, if the first datum specified by the first read command is in the level-two memory 30, the control unit 42 will store the first datum to the corresponding address in the level-one memory 20 of the reject datum. Namely, the level-two memory 30 will read the stored data therein according to the first read command and return the first datum specified by the first read command to the first memory unit 200. At this moment, the control unit 42 can also check if a second datum specified by the second read command is stored in the level-two memory 30. The actions described above can be performed simultaneously, and hence enhancing the access efficiency of the cache memory according to the present invention.

Afterwards, the control unit 42 reads the data of the level-two memory 30 and stores them to the second memory unit 202. Thereby, according to the present invention, the operations when both of the first and second memory units 200, 202 need to read the data in the level-two memory 30 can be carried out rapidly. It is not required that the second memory unit 202 cannot interchange data with the level-two memory 30 until the data interchange between the first memory unit 200 and the level-two memory 30 is completed.

In addition, after the control unit 42 stores the data in the level-two memory 30 to the level-one memory 20, it can change and store the reject datum stored in the register unit 40, which can be a buffer, to the level-two memory 30.

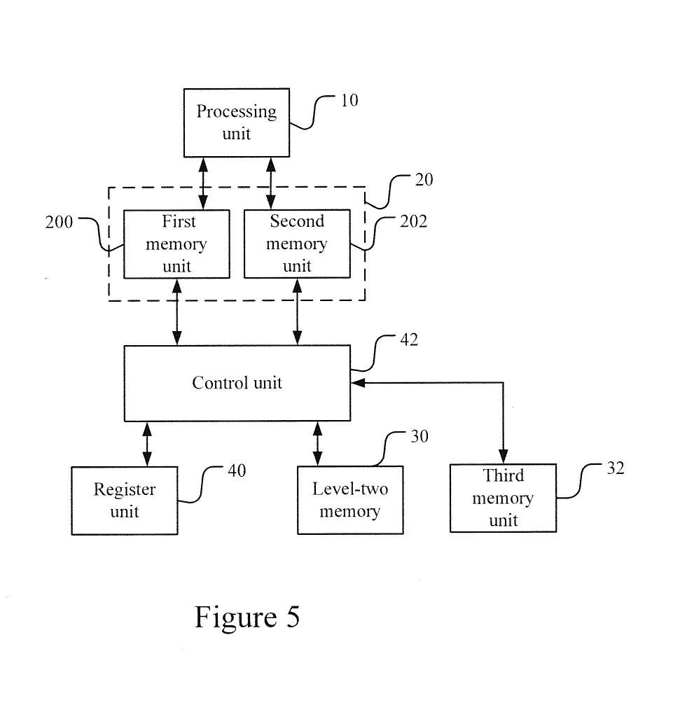

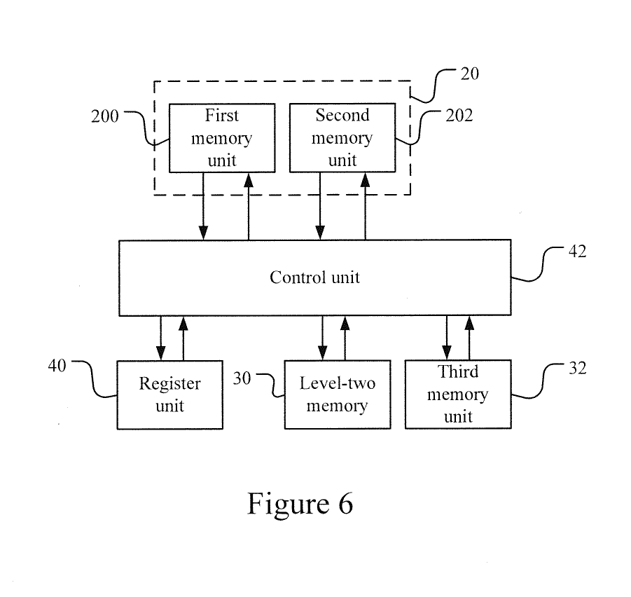

FIG. 5 shows a schematic diagram of data access according to another preferred embodiment of the present invention and FIG. 6 shows a schematic diagram of data access according to the preferred embodiment of FIG. 5. As shown in the figures, the apparatus for accessing a cache memory according to the present embodiment can further comprise a third memory unit 32. The third memory unit 32 is used for storing a plurality of data of a plurality of specific addresses and can be a scratch-pad memory for storing the plurality of data of the plurality of specific addresses. When the second memory unit 202 is accessing data in the level-two memory 30, the second memory unit 202 transmits a read command to the control unit 42. At this moment, the second memory unit 202 will reject the reject datum to the control unit 42, which will store the reject datum to the register unit 40. According to the present embodiment, the register unit 40 registers the plurality of data of the plurality of specific addresses stored in the third memory unit 32. The control unit 42 searches the level-two memory 30 and the third memory unit according to the read command. If the datum is found in the third memory unit 32, the control unit 42 will read and store the datum to the second memory unit 202 of the level-one memory 20, and stores the reject datum stored in the register unit 40 to the third memory unit 32. In other words, the control unit 42 interchanges the reject datum in the second memory unit 202 of the level-one memory 20 with the datum in the third memory unit 32. Thereby, errors occurred when the control unit 42 accesses the stored data in the third memory unit 32 can be avoided. The third memory unit 32 further includes a plurality of flags corresponding to the plurality of data, respectively. Thus, the control unit 42 can access the plurality of data by means of the plurality of flags.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An apparatus for accessing a cache memory, wherein said cache memory comprising a level-one memory and a level-two memory, comprising:
a register unit, used for storing a reject datum rejected by said level-one memory; and
a control unit, used for receiving a first read command, storing said reject datum to said register unit, and reading and storing a stored datum of said level-two memory to said level-one memory according to said first read command.

2. The apparatus for accessing a cache memory of claim 1. wherein said control unit stores said stored datum of said level-two memory to the corresponding address of said reject datum in said level-one memory.

3. The apparatus for accessing a cache memory of claim 1, wherein when said control unit receives said first read command and said level-one memory has no extra storage space, said control unit rejects one of a plurality of stored data stored in said level-one memory as said reject datum and stores said reject datum to said register unit.

4. The apparatus for accessing a cache memory of claim 1, wherein after said control unit stores said stored datum of said level-two memory to said level-one memory, said control unit stores said reject datum of said register unit to said level-two memory.

5. The apparatus for accessing a cache memory of claim 1, further comprising a memory unit used for storing a plurality of data of a plurality of specific addresses.

6. The apparatus for accessing a cache memory of claim 5, wherein said memory unit is a scratch-pad memory, and said register unit registers said plurality of data of said plurality of specific addresses stored in said scratch-pad memory.

7. A method for accessing a cache memory, wherein said cache memory comprising a level-one memory and a level-two memory, comprising steps of:
receiving a first read command;
receiving a reject datum of said level-one memory;
storing said reject datum to a register unit;
reading a first datum of said level-two memory according to said first read command; and
storing said first datum to said level-one memory.

8. The method for accessing a cache memory of claim 7, wherein said step of storing said first datum to said level-one memory is storing said first datum to the corresponding address of said reject datum in said level-one memory.

9. The method for accessing a cache memory of claim 7, wherein said level-one memory includes a first memory unit and a second memory unit and said first read command is produced by said first memory unit, and the method further comprising steps of:
checking if said first datum specified by said first read command is stored in said level-two memory; and
receiving a second read command produced by said second memory unit;
wherein said above two steps are performed simultaneously.

10. The method for accessing a cache memory of claim 9, further comprising a step of checking if a second datum specified by said second read command is stored in said level-two memory; wherein said above step and said step of storing said first datum to said level-one memory are performed simultaneously.

11. The method for accessing a cache memory of claim 10, further comprising a step of storing said second datum to said level-one memory.

12. The method for accessing a cache memory of claim 7. further comprising a step of rejecting one of a plurality of stored data stored in said level-one memory, which one of said plurality of stored data is said reject datum.

13. The method for accessing a cache memory of claim 7, further comprising a step of storing said reject datum in said register unit to said level-two memory.

14. The method for accessing a cache memory of claim 7, further comprising a step of storing a plurality of data of a plurality of specific addresses to a third memory unit.

15. The method for accessing a cache memory of claim 14, wherein said register unit registers said plurality of data of said plurality of specific addresses stored in said third memory unit in said step of storing said reject datum of said level-one memory to said register unit.
